(19) United States
(12) Patent Application Publication
(10) Pub. No.: US 2015/0045519 A1
(43) Pub. Date: Feb. 12, 2015

(54) COMPOSITION BASED ON SILANE-TERMINATED POLYMERS

(71) Applicant: SIKA TECHNOLOGY AG, Baar (CH)

(72) Inventors: Daniele Rutz, Zurich (CH); Ghazale Azarmgin, Zurich (CH)

(21) Appl. No.: 14/384,642

(22) PCT Filed: Mar. 19, 2013
(86) PCT No.: PCT/EP2013/055624

§ 371 Date: Sep. 11, 2014

(30) Foreign Application Priority Data
Mar. 19, 2012 (EP) 12160128.0

(51) Int. Cl. C09J 175/04

(52) U.S. Cl. CPC C09J 175/04
USPC 525/460

(57) ABSTRACT

A composition is described that includes a) at least one silane-functional polymer P, b) at least one organotin compound, and also c) at least one titanate, where the proportion of organotin compound is from 0.01 to 0.15% by weight and the proportion of titanate is from 0.05 to 1% by weight, based in each case on the entire composition.

### AREA OF TECHNOLOGY

The invention relates to moisture-curing compositions based on silane-functional polymers, which can be used as adhesives, sealants or coatings.

### PRIOR ART

Moisture-curing compositions based on silane-functional polymers are known and have long been used as elastic adhesives, sealants and coatings.

Organotin compounds in particular are used as catalyst or accelerator systems for the cross-linking of compositions containing silane-functional polymers in the presence of water. The use of titanates for this purpose is also known.

It was found that systems cured with titanates exhibit superior mechanical properties compared to the system with organotin compounds, which generally presents a significant advantage.

The drawback of such compositions, on the other hand, lies in the fact that the use of the titanates compared to the organotin compounds results in a distinct reduction of the curing reactivity of the composition.

### PRESENTATION OF THE INVENTION

Therefore the goal of the present invention is to supply a moisture-curing composition based on silane-functional polymers which has improved mechanical properties in the cured state and at the same time has a short skin formation time during curing.

Surprisingly it has now been found that compositions according to claim 1 solve this problem.

The use of organotin compounds and titanates in the exactly defined parts by weight makes it possible to supply compositions which have improved mechanical properties in the cured state without the skin formation time changing in a way that would require adjustments to the application and processing processes.

### METHODS OF EXECUTING THE INVENTION

The subject matter of the present invention is a composition comprising

a) at least one silane-functional polymer P,
b) at least one organotin compound and
c) at least one titanate,

wherein the proportion of organotin compound is 0.01 to 0.15% by weight and the proportion of titanate is 0.05 to 1% by weight, in each case based on the entire composition.

Substance names beginning with “poly” such as polyol or polyisocyanate in the present document refer to substances, the formula of which contains two or more of the functional groups occurring in their name per molecule.

The term “polymer” in the present document on one hand comprises a group of chemically uniform macromolecules that differ in terms of their degree of polymerization, molecular weight and chain length, and are produced by a polyreaction (polymerization, polyaddition, polycondensation). The term also covers derivatives of such a group of macromolecules from polyreactions, thus compounds produced by reactions such as additions or substitutions of functional groups on preexisting macromolecules, and which may be chemically uniform or chemically non-uniform. The term furthermore covers so-called prepolymers, in other words, reactive oligomeric pre-adducts, the functional groups of which are involved in the makeup of macromolecules.

The term “polyurethane polymer” comprises all polymers produced by the so-called diisocyanate polyaddition method. This also includes polymers that are practically or entirely free from urethane groups. Examples of polyurethane polymers are polyether-polyurethanes, polyester-polyurethanes, polyethers, polyureas, polyester-polyureas, polyisocyanurates and polycarbodiimides.

In the present documents the terms “silane” and “organosilane” stands for compounds which on one hand have at least one, usually two or three, alkoxy groups or acyloxy groups bound over Si—O bonds directly to the silicon atom, and on the other hand an organic radical bound directly to the silicon atom over a Si—C bond. Such silanes are also known to the person skilled in the art as organoalkoxysilanes and organoacyloxysilanes.

Correspondingly the term “silane group” indicates the silicon-containing group bound to the organic radical of the silane over the Si—C bond. The silanes, or their silane groups, have the characteristic of hydrolyzing on contact with moisture. In this process, organosilanols form, in other words, organosilicon compounds containing one or more silanol groups (Si—OH groups) and in subsequent condensation reactions, organosiloxanes, in other words organosilicon compounds containing one or more siloxane groups (Si—O—Si-groups). The term “silane-functional” designates compounds containing silane groups. “Silane-functional polymers” are thus polymers that have at least one silane group.

“Aminosilanes” and “mercaptosilanes” are the terms applied to organosilanes wherein the organic residue contains an amino group and a mercapto group. “Primary aminosilanes” designates aminosilanes that have a primary amino group, thus a NH₂ group bonded to an organic radical. “Secondary aminosilanes” are aminosilanes that have a secondary amino group, thus a NH group, bonded to two organic radicals.

In the present document, “molecular weight” is always defined as the mean molecular weight Mₙ (weight-average).

“Room temperature” is defined in the present document as a temperature of 23° C.

The composition according to the invention contains at least one silane-functional polymer P, which especially has end groups of formula (I).

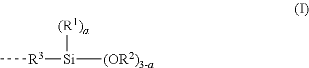

Here, the radical R¹ represents a linear or branched, monovalent hydrocarbon radical with 1 to 8 C atoms, especially a methyl or ethyl group.

The radical R² represents an acyl radical or a linear or branched, monohydric hydrocarbon radical with 1 to 5 C atoms, especially a methyl, ethyl or isopropyl group. The subscript a represents a value of 0 or 1 or 2, especially a value of 0.

The radical R³ represents a linear or branched, divalent hydrocarbon radical with 1 to 12 C atoms, which optionally has cyclic and/or aromatic moieties and optionally one or more heteroatoms, especially one or more nitrogen atoms.

Within a silane group of formula (I), R¹ and R² each independently of one another represent the radicals described. For example, compounds with end groups of formula (I) that are ethoxydimethoxysilane end groups (R²=methyl, R²=methyl, R²=ethyl) are possible.

In a first embodiment, the silane-functional polymer P is a silane-functional polyurethane polymer P1, which can be obtained by reacting a silane containing at least one group reactive toward isocyanate groups with a polyurethane polymer containing isocyanate groups. This reaction is preferably performed at a stoichiometric ratio of the groups reactive toward isocyanate groups to isocyanate groups of 1:1 or with a slight excess of groups reactive toward isocyanate groups, so that the resulting silane silane-functional polyurethane polymer P1 is entirely free of isocyanate groups.

In the reaction of the silanes containing at least one group reactive toward isocyanate groups with a polyurethane polymer that has isocyanate groups, the silane can theoretically, although not preferably, be used in a substoichiometric quantity, so that a silane-functional polymer is obtained which has both silane groups and isocyanate groups.

The which has at least one group reactive toward isocyanate groups, is for example a mercaptosilane or an aminosilane, especially an aminosilane.

Preferably the aminosilane is an aminosilane AS of formula (II),

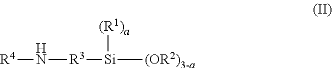

wherein R¹, R², R³ and a were already described in the preceding and R⁴ represents a hydrogen atom or a linear or branched, monovalent hydrocarbon radical with 1 to 20 C atoms, optionally containing cyclic moieties, or a radical of formula (III).

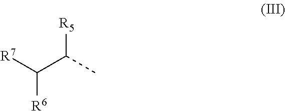

Here the radicals R⁵ and R⁶ each independently of one another represent a hydrogen atom or a radical from the group consisting of —R⁸, —COOR⁸ and —CN.

The radical R⁷ represents a hydrogen atom or a radical from the group consisting of—CH₂—COOR⁸, —COOR⁸, —CONHR⁸, —CON(R⁸)₂, —CN, —NO₂, —PO(OR⁸)₂, —SO₂R⁸ and —SO₂OR⁸.

The radical R⁸ represents a hydrocarbon radical with 1 to 20 C atoms, optionally having at least one heteroatom.

Examples of suitable aminosilanes AS are primary aminosilanes such as 3-aminopropyltrimethoxysilane, 3-aminopropyldimethoxymethylsilane; secondary aminosilanes such as N-butyl-3-aminopropyltrimethoxysilane, N-phenyl-3-aminopropyl-trimethoxysilane; the products from the Michael-type addition of primary aminosilanes such as 3-aminopropyltrimethoxysilane or 3-aminopropyldimethoxymethylsilane to Michael acceptors such as acrylonitrile, (meth)acrylic acid esters, (meth)acrylic acid amides, maleic acid and fumaric acid diesters, citraconic acid diesters and itaconic acid diesters, for example N-(3-trimethoxysilyl-propyl)-amino succinic acid dimethyl and diethyl esters; and analogs of the aminosilanes mentioned with ethoxy or isopropoxy groups instead of the methoxy groups on the silicon. Particularly suitable as aminosilanes AS are secondary aminosilanes, especially aminosilanes AS in which R⁴ in formula (II) is different from H. The Michael-type adducts, especially N-(3-trimethoxysilyl-propyl)-aminosuccinic acid diethyl ester, are preferred.

The term “Michael acceptor” in the present document denotes compounds which because of the double bonds they contain, activated by electron acceptor radicals, are able to undergo nucleophilic addition reactions with primary amino groups (NH₂ groups) in a manner analogous to Michael addition (hetero-Michael addition).

Examples of isocyanate group-containing polyurethane polymers for producing a silane-functional polyurethane polymer P1 include polymers obtainable by reacting at least one polyol with at least one polyisocyanate, especially a diisocyanate. This reaction can take place in that the polyol and the polyisocyanate are made to react by the usual methods, for example at temperatures of 50° C. to 100° C., optionally using suitable catalysts, wherein the polyisocyanate is added at a rate such that the isocyanate groups thereof are present in stoichiometric excess relative to the hydroxyl groups of the polyol.

In particular, the excess of polyisocyanate is selected such that after the reaction of all the hydroxyl groups of the polyol, the resulting polyurethane polymer has a remaining free isocyanate group content of 0.1 to 5% by weight, preferably 0.1 to 2.5% by weight, particularly preferably 0.2 to 1% by weight, based on the total polymer.

Optionally the polyurethane polymer can be produced with the simultaneous use of plasticizers, wherein the plasticizers used contain no groups reactive toward isocyanates.

Polyurethane polymers the free isocyanate group content mentioned, obtained from the reaction of diisocyanates with high molecular weight diols in a NCO:OH-ratio of 1.5:1 to 2.2:1, are preferred.

Especially suitable polyols for producing the polyurethane polymers are polyether polyols, polyester polyols and polycarbonate polyols as well as mixtures of these polyols.

Particularly suitable polyether polyols, also called polyoxyalkylene polyols or oligoetherols, are those that are polymerization products of ethylene oxide, 1,2-propylene oxide, 1,2- or 2,3-butylene oxide, oxetane, tetrahydrofuran or mixtures thereof, optionally polymerized using a starter molecule with two or more active hydrogen atoms, for example water, ammonia or compounds with several OH or NH groups such as 1,2-ethane diol, 1,2- and 1,3-propane diol, neopentyl glycol, diethylene glycol, triethylene glycol, the isomeric dipropylene glycols and tripropylene glycols, the isomeric butane diols, pentane diols, hexane diols, heptane diols, octane diols, nonane diols, decane diols, undecane diols, 1,3- and 1,4-cyclohexanedimethanol, bisphenol A, hydrogenated bisphenol A, 1,1,1-trimethylolethane, 1,1,1-trimethylolpropane, glycerol, aniline, as well as mixtures of the compounds mentioned. Both polyoxyalkylene polyols that have a low degree of unsaturation (measured according to ASTM D-2849-69 and reported in milliequivalents of unsaturation per gram polyol (mEq/g)), produced for example with the aid of so-called Double Metal Cyanide complex catalysts (DMC catalysts), and polyoxyalkylene polyols with a higher degree of unsaturation, produced for example with the aid of anionic catalysts such as NaOH, KOH, CsOH or alkali alcoholates, may be used.

Particularly suitable are polyoxyethylene polyols and polyoxypropylene polyols, especially polyoxyethylene diols, polyoxypropylene diols, polyoxyethylene triols and polyoxypropylene triols.

Especially suitable are polyoxyalkylene diols or polyoxyalkylene triols with a degree of unsaturation of less than 0.02 mEq/g and with a molecular weight in the range of 1,000 to 30,000 g/mol, as well as polyoxyethylene diols, polyoxyethylene triols, polyoxypropylene diols and polyoxypropylene triols with a molecular weight of 400 to 20,000 g/mol. Also particularly suitable are so-called ethylene oxide-terminated (“EO-endcapped”, ethylene oxide-endcapped) polyoxypropylene polyols. These are special polyoxypropylene-polyoxyethylene polyols, obtained for example in that pure polyoxypropylene polyols, especially polyoxypropylene diols and triols, after completion of the polypropoxylation reaction with ethylene oxide, are further alkoxylated and thus have primary hydroxyl groups. Preferred in this case are polyoxypropylene-polyoxyethylene diols and polyoxypropylene-polyoxyethylene triols.

Also suitable are hydroxyl group-terminated polybutadiene polyols, for example those produced by polymerization of 1,3-butadiene and allyl alcohol or by oxidation of polybutadiene, as well as the hydrogenation products thereof.

Also suitable are styrene-acrylonitrile-grafted polyether polyols, for example those commercially available under the trade name of Lupranol® from Elastogran GmbH, Germany.

Especially suitable as polyester polyols are polyesters that have at least two hydroxyl groups attached and are produced by known methods, especially the polycondensation of hydroxycarboxylic acids or the polycondensation of aliphatic and/or aromatic polycarboxylic acids with dihydric or polyhydric alcohols.

Especially suitable are polyester polyols produced from dihydric to trihydric alcohols such as 1,2-ethane diol, diethylene glycol, 1,2-propane diol, dipropylene glycol, 1,4-butane diol, 1,5-pentane diol, 1,6-hexane diol, neopentyl glycol, glycerol, 1,1,1-trimethylolpropane or mixtures of the aforementioned alcohols with organic dicarboxylic acids or the anhydrides or esters thereof, for example succinic acid, glutaric acid, adipic acid, trimethyladipic acid, suberic acid, azelaic acid, sebacic acid, dodecane dicarboxylic acid, maleic acid, fumaric acid, dimer fatty acid, phthalic acid, phthalic acid anhydride, isophthalic acid, terephthalic acid, dimethyl terephthalate, hexahydrophthalic acid, trimellitic acid and trimellitic acid anhydride or mixtures of the aforementioned acids, as well as polyester polyols from lactones such as ε-caprolactone.

Particularly suitable are polyester diols, especially those produced from adipic acid, azelaic acid, sebacic acid, dodecane dicarboxylic acid, dimer fatty acid, phthalic acid, isophthalic acid and terephthalic acid as the dicarboxylic acid or from lactones such as ε-caprolactone and from ethylene glycol, diethylene glycol, neopentyl glycol, 1,4-butane diol, 1,6-hexane diol, dimer fatty acid diol and 1,4-cyclohexane dimethanol as the dihydric alcohol.

Especially suitable as polycarbonate polyols are those that can be obtained by reacting for example the above-mentioned alcohols used for building the polyester polyols, with dialkyl carbonates such as dimethyl carbonate, diaryl carbonates such as diphenyl carbonate or phosgene. Particularly suitable are polycarbonate diols, especially amorphous polycarbonate diols.

Additional suitable polyols are poly(meth)acrylate polyols.

Further suitable are polyhydroxyfunctional fats and oils, for example natural fats and oils, especially castor oil, or so-called oleochemical polyols obtained by chemical modification of natural fats and oils, the epoxy polyesters and epoxy polyethers obtained for example by epoxidation of unsaturated oils followed by ring opening with carboxylic acids and alcohols, or polyols obtained by hydroformylation and hydrogenation of unsaturated oils. Additionally suitable are polyols obtained from natural fats and oils by degradation processes such as alcoholysis or ozonolysis and subsequent chemical bonding, for example by ester exchange or dimerization, of the degradation products thus obtained or derivatives thereof. Suitable degradation products of natural fats and oils are especially fatty acids and fatty alcohols as well as fatty acid esters, especially the methyl esters (FAME), which can be derivatized for example by hydroformylation and hydrogenation to produce hydroxy fatty acid esters.

Also suitable are polyhydrocarbon polyols, also called oligohydrocarbonols, for example polyhydroxyfunctional ethylene-propylene-, ethylene-butylene- or ethylene-propylene-diene copolymers, such as those manufactured for example by Kraton polymers, USA, or polyhydroxyfunctional copolymers made from dienes such as 1,3-butadiene or diene mixtures and vinyl monomers such as styrene, acrylonitrile or isobutylene, or polyhydroxyfunctional polybutadiene polyols, for example those produced by copolymerization of 1,3-butadiene and allyl alcohol, and they may also be hydrogenated.

Also suitable are polyhydroxyfunctional acrylonitrile/butadiene copolymers, for example copolymers that may be produced from epoxides or amino alcohols and carboxyl-terminated acrylonitrile/butadiene copolymers, commercially available under the name of Hypro® (previously Hycar®) CTBN from Emerald Performance Materials, LLC, USA.

These polyols mentioned preferably have a mean molecular weight of 250 to 30,000 g/mol, especially of 1,000 to 30,000 g/mol, and a mean OH functionality in the range of 1.6 to 3.

Particularly suitable polyols are polyester polyols and polyether polyols, especially polyoxyethylene polyol, polyoxypropylene polyol and polyoxypropylene polyoxyethylene polyol, preferably polyoxyethylene diol, polyoxypropylene diol, polyoxyethylene triol, polyoxypropylene triol, polyoxypropylene polyoxyethylene diol and polyoxypropylene polyoxyethylene triol.

In addition to these polyols mentioned, small amounts of low-molecular-weight dihydric or polyhydric alcohols such as 1,2-ethane diol, 1,2- and 1,3-propane diol, neopentyl glycol, diethylene glycol, triethylene glycol, the isomeric dipropylene glycols and tripropylene glycols, the isomeric butane diols, pentane diols, hexane diols, heptane diols, octane diols, nonane diols, decane diols, undecane diols, 1,3- and 1,4-cyclohexane dimethanol, hydrogenated bisphenol A, dimeric fatty alcohols, 1,1,1-trimethylol ethane, 1,1,1-trimethylol propane, glycerol, pentaerythritol, sugar alcohols such as xylitol, sorbitol or mannitol, sugars such as sucrose, other higher-hydric alcohols, low molecular weight alkoxylation products of the aforementioned dihydric and polyhydric alcohols, as well as mixtures of the aforementioned alcohols in manufacturing the polyurethane polymers that have terminal isocyanate groups may be added.

Commercial polyisocyanates, especially diisocyanates, can be used as polyisocyanates for manufacturing the polyurethane polymer.

Examples of suitable diisocyanates are 1,6-hexamethylene diisocyanate(HDI), 2-methyl-pentamethylene-1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexan-1,3-diisocyanate, cyclohexane-1,4-diisocyanate, 1-socyanato-3,3,5-trimethyl-5-isocyanatomethyl-cyclohexane (=isophorone diisocyanate or IPDI), perhydro-2,4′-diphenyl methane diisocyanate and perhydro-4,4′-diphenylmethane diisocyanate, 1,4-di-isocyanato-2,2,6-trimethylcyclohexane (TMCDI), 1,3- and 1,4-bis-(isocyanatomethyl)-cyclohexane, m- and p-xylylene diisocyanate (m- and p-XDI), m- and p-tetramethyl-1,3-xylylene diisocyanate, m- and p-tetramethyl-1,4-xylylene diisocyanate, bis-(1-isocyanato-1-methylethyl)-naphthalene, 2,4- and 2,6-toluylene diisocyanate (TDI), 4,4′-, 2,4′- and 2,2′-diphenylmethan diisocyanate (MDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), oligomers and polymers of the aforementioned isocyanates, as well as arbitrary mixtures of the aforementioned Isocyanates.

Examples of suitable silane-functional polymers P1 are commercially available under the trade names of polymer ST, for example polymer ST50, from Hanse Chemie AG, Germany, as well as under the trade name of Desmoseal® from Bayer MaterialScience AG, Germany.

In a second embodiment the silane-functional polymer P is a silane-functional polyurethane polymer P2, obtainable by the reaction of an isocyanatosilanes IS with a polymer, which has functional end groups reactive toward isocyanate groups, especially hydroxyl groups, mercapto groups and/or amino groups. This reaction takes place in a stoichiometric ratio of the isocyanate groups to the functional end groups reactive toward isocyanate groups of 1:1, or with a slight excess of the functional end groups reactive toward isocyanate groups, for example at temperatures of 20° C. to 100° C., optionally with addition of catalysts.

Suitable isocyanatosilanes IS are compounds of formula (IV).

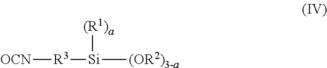

wherein R¹, R², R³ and a were already described in the preceding.

Examples of suitable isocyanatosilanes IS of formula (IV) are isocyanatomethyl trimethoxysilane, isocyanatomethyl dimethoxy methylsilane, 3-isocyanatopropyl trimethoxysilane, 3-isocyanatopropyldimethoxymethylsilane, and the analogs thereof with ethoxy or isopropoxy groups instead of the methoxy groups on the silicon.

Preferably the polymer has hydroxyl groups as functional end groups reactive toward isocyanate groups.

Suitable as hydroxyl group-containing polymers on one hand are previously mentioned high-molecular-weight polyoxyalkylene polyols, preferably polyoxypropylene diols with a degree of unsaturation of less than 0.02 mEq/g and with a molecular weight in the range of 4,000 to 30,000 g/mol, especially those with a molecular weight in the range of 8,000 to 30,000 g/mol.

Also suitable for reaction with isocyanatosilanes IS of formula (IV), on the other hand, are hydroxyl group-containing, especially hydroxyl group-terminated, polyurethane polymers. Such polyurethane polymers can be obtained by the reaction of at least one polyisocyanate with at least one polyol. This reaction can take place in that the polyol and the polyisocyanate are made to react using customary methods, for example at temperatures of 50° C. to 100° C., optionally with the addition of suitable catalysts, wherein the polyol is added at a rate such that the hydroxyl groups thereof are present in stoichiometric excess relative to the isocyanate groups of the polyisocyanates. Preferred is a ratio of hydroxyl groups to isocyanate groups of 1.3:1 to 4:1, especially of 1.8:1 to 3:1.

If desired, the polyurethane polymer can be produced with the additional use of plasticizers, wherein the plasticizers used do not contain any groups reactive toward isocyanates.

Suitable for this reaction are the same polyols and polyisocyanates that were previously mentioned as suitable for producing an isocyanate group-containing polyurethane polymer which is used for producing a silane-functional polyurethane polymer P1.

For example, suitable silane-functional polymers P2 are commercially available under the trade names of SPUR® 1010LM, 1015LM and 1050MM from Momentive Performance Materials Inc., USA, as well as under the trade names of Geniosil® STP-E15, STP-10 and STP-E35 from Wacker Chemie AG, Germany.

In a third embodiment the silane-functional polymer P is a silane-functional polymer P3 which is obtainable by hydrosilylation reaction of polymers with terminal double bonds, for example poly(meth)acrylate polymers or polyether polymers, especially of allyl-terminated polyoxyalkylene polymers, described for example in U.S. Pat. No. 3,971,751 and U.S. Pat. No. 6,207,766, the entire disclosure of which is incorporated herewith.

For example, suitable silane-functional polymers P3 are commercially available under the trade names of MS Polymer™ S203H, S303H, S227, S810, MA903 und S943, Silyl™ SAX220, SAX350, SAX400 and SAX725, Silyl™ SAT350 and SAT400, as well as XMAP™ SA100S and SA310S from Kaneka Corp., Japan, as well as under the trade names of Excestar® S2410, S2420, S3430, S3630, W2450 and MSX931 from Asahi Glass Co, Ltd., Japan.

The silane-functional polymer P is usually present in a quantity of 10 to 80% by weight, especially in a quantity of 15 to 70% by weight, preferably 20 to 40% by weight, based on the entire composition.

In addition, the composition according to the invention includes at least one organotin compound.

Preferred organotin compounds are dialkyltin compounds such as those selected from the group consisting of dimethyltin-di-2-ethylhexanoate, dimethyltin dilaurate, di-n-butyltin diacetate, di-n-butyltin-di-2-ethylhexanoate, di-n-butyltin dicaprylate, di-n-butyltindi-2,2-di-methyl-octanoate, di-n-butyltin dilaurate, di-n-butyltin distearate, di-n-butyltin dimaleate, di-n-butyltin dioleate, di-n-butyltin diacetate, di-n-butyltin dioxide, di-n-octyltin-di-2-ethylhexanoate, di-n-octyltindi-2,2-dimethyl octanoate, di-n-octyltin dimaleate and di-n-octyltin dilaurate.

Naturally it is possible or even preferable in some cases to use mixtures of different organotin compounds.

The proportion of the organotin compound amounts to 0.01 to 0.15% by weight, especially 0.05 to 0.1% by weight, based on the total composition.

In addition the composition according to the invention contains at least one titanate.

Titanates or organotitanates are the names given to compounds that have at least one ligand bonded to the titanium atom over an oxygen atom. Suitable ligands bonded to the titanium atom over an oxygen-titanium bond include those selected from the group consisting of alkoxy group, sulfonate group, carboxylate group, dialkyl phosphate group, dialkyl pyrophosphate group, acetoacetate group und acetylacetonate group. Preferred titanates are, for example, tetrabutyl or tetraisopropyl titanate.

Particularly suitable titanates have at least one multidentate ligand, also called a chelate ligand. In particular the multidentate ligand is a bidentate ligand.

Preferably the bidentate ligand is a ligand of formula (V)

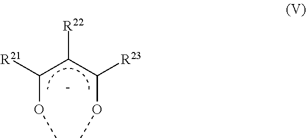

Here the radical R²¹ represents a hydrogen atom or a linear or branched alkyl group with 1 to 8 C atoms, especially a methyl group.

The radical R²² represents a hydrogen atom or a linear or branched alkyl group with 1 to 8 C atoms, which optionally contains heteroatoms, especially a hydrogen atom.

The radical R²³ represents a hydrogen atom or an alkyl group with 1 to 8, especially 1 to 3, C atoms or a linear or branched alkoxy group with 1 to 8, especially 1 to 3, C atoms.

The titanate is especially preferably a titanate of formula (VI).

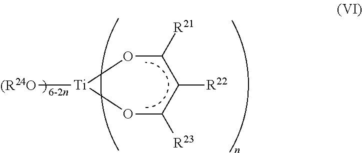

The radicals R²¹, R²² and R²³ were already described in the preceding.

The radical R²⁴ represents a linear or branched alkyl radical with 2 to 20 C atoms, especially an isobutyl- or an isopropyl radical.

n represents a value of 1 or 2, especially 2.

Preferred are titanates of formula (VI) in which the radical R²¹ represents a methyl group, the radical R²² represents a hydrogen atom, the radical R²³ represents a methyl group or methoxy or ethoxy group and the radical R²⁴ represents an isobutyl or isopropyl radical.

Suitable titanates are commercially available for example from Dorf Ketal under the trade names Tyzor® AA, GBA, GBO, AA-75, AA-65, AA-105, DC, BEAT, IBAY or are commercially available from Borica under the trade names of Tytan™ PBT, TET, X85, TAA, ET, S2, S4 or S6.

Naturally it is possible or even preferable in some cases to use mixtures of different titanates.

The proportion of the titanate amounts to 0.05 to 1% by weight, preferably 0.1 to 0.6% by weight, especially 0.1 to 0.3% by weight, based on the overall composition.

In addition, the composition also preferably contains at least one filler. The filler influences the rheologic properties of the uncured composition as well as the mechanical properties and surface texture of the cured composition. Suitable fillers are inorganic and organic fillers, for example natural, ground or precipitated calcium carbonates, optionally coated with fatty acids, especially stearic acid, barium sulfate (BaSO₄, also known as baryta or heavy spar), calcined kaolin, aluminum oxide, aluminum hydroxide, silicon dioxide, especially highly disperse silicon dioxide from pyrolysis processes, carbon blacks, especially industrially produced carbon black, PVC powder or hollow beads. Preferred fillers are calcium carbonate, calcined kaolin, carbon black, high dispersity silicon dioxide and flame-retardant fillers, such as hydroxides or hydrates, especially hydroxides or hydrates of aluminum, preferably aluminum hydroxide.

It is entirely possible and may even be advantageous to use a mixture of different fillers.

A suitable quantity of filler falls for example in the range of 20 to 60% by weight, preferably 30 to 60% by weight, based on the entire composition.

In addition, the composition according to the invention may contain other components. Examples of such components are plasticizers such as esters of organic carboxylic acids or the anhydrides thereof, such as phthalates, for example dioctyl phthalate, diisononyl phthalate or diisodecyl phthalate, adipates, for example dioctyl adipate, azelates and sebacates, polyols, for example polyoxyalkylene polyols or polyester polyols, organic organophosphorus and sulfonic acid esters or polybutenes; solvents; fibers, for example made of polyethylene; dyes; pigments; rheology modifiers such as thickeners or thixotropic agents, for example urea compounds of the type described as “thixotropy endowing agent” in WO 02/48228 A2 on pages 9 to 11, polyamide waxes, bentonites or pyrogenic silicon dioxides; adhesive promoters, for example epoxysilanes, (meth)acrylsilanes, anhydridosilanes or adducts of the aforementioned silanes with primary aminosilanes, as well as aminosilanes or urea silanes; cross-linking agents, for example silane-functional oligomers and polymers; drying agents, for example vinyltrimethoxysilanes, [symbol] unctional silanes such as N-(silylmethyl)-O-methyl-carbamates, especially N-(methyldimethoxysilylmethyl)-O-methyl-carbamate, (methacryloxymethyl) silanes, methoxymethyl silanes, N-phenyl-, N-cyclohexyl- and N-alkyl silanes, orthoformic acid esters, calcium oxide or molecular sieves; stabilizers, for example against heat, light and UV-radiation; flame retarding substances; surface-active substances such as wetting agents, leveling agents, deaerating agents or defoamers; biocides such as algicides, fungicides or the fungal growth inhibiting substances; as well as additional substances customarily used in moisture-curing compositions.

In addition, so-called reactive diluents may be use, which during the curing of the composition are bound into the polymer matrix, especially by reaction with the silane groups.

It is advantageous to select all of the constituents mentioned as optionally present in the composition, especially filler and catalyst and accelerator systems, such that the shelf life of the composition is not negatively affected by the presence of such a constituent, in other words, that the properties of the composition, especially the application and curing properties, do not change or only change slightly during storage. This means that the reactions that result in chemical curing of the composition described, especially of the silane groups, do not take place to any significant extent during storage. It is therefore especially advantageous for the constituents named to contain no or at most traces of water or release such during storage. Therefore it may be advisable to dry certain constituents chemically or physically before mixing them into the composition.

The above described composition is preferably produced and stored under exclusion of moisture. Typically the composition is storage-stable, in other words, it can be stored for several months to one year or more under exclusion of moisture in a suitable package or arrangement, such as a drum, a bag or a cartridge without its application properties or its properties after curing changing to an extent relevant for its use. Usually the storage stability is determined by measuring the viscosity or the push-out force.

During the application of the described composition to at least one solid or article, the silane groups contained in the composition come into contact with moisture. The silane groups have the characteristic of hydrolyzing upon contact with moisture. In this process, organosilanols form, and then, but subsequent condensation reactions, organosiloxanes. As a result of these reactions, which can be accelerated through the use of catalysts or accelerators, the composition finally cures completely. This process is also known as cross-linking.

The water required for curing can either come from the air (atmospheric humidity), or the previously described composition can be brought into contact with a water-containing component, for example by painting, e.g., in the case of a smoothing agent, or by spraying, or a water-containing component can be added to the composition during application, for example in the form of a water-containing paste which is mixed in, for example, using a static mixer. Upon curing with atmospheric humidity, the composition cures from the outside to the inside. The rate of curing is determined here by various factors, such as the diffusion rate of the water, the temperature, the atmospheric humidity and the geometry of the bond, and as a rule, decreases as the curing progresses.

Furthermore the present invention comprises the use of at least one organotin compound together with at least one titanate as a catalyst or accelerator system for the cross-linking of compositions containing silane-functional polymers in the presence of water, wherein the proportion of organotin compound amounts to 0.01 to 0.15% by weight and the proportion of titanate to 0.05 to 1% by weight, in each case based on the entire composition.

This use of a specific catalyst or accelerator system has the advantage that a composition containing silane-functional polymers in the cured state has improved mechanical properties and nevertheless has a short skin formation time during curing.

Typically a composition according to the invention in the cured state, i.e., in this case after curing of the composition for 7 days at 23° C. and 50% relative humidity, has a tensile strength of ≧2 MPa, an elongation at break of ≧450%, especially of ≧500%, and a tensile shear strength of ≧1.5 MPa. During curing under the indicated conditions, the skin formation time is typically less than 2 hours, especially less than 1 hour.

The measurement methods for the indicated values are described within the framework of the embodiments.

Furthermore the present invention comprises the use of a previously described composition as a moisture-curing adhesive, sealant or coating, especially as a construction sealant. The use as a low-modulus construction sealant for connection or expansion joints.

The composition according to the invention is especially used in a method of bonding two substrates S1 and S2 comprising the steps:

i) Application of a composition according to the preceding description to a substrate SI and/or a substrate S2;
ii) Bringing the substrate SI and S2 into contact over the applied composition within the open time of the composition;
iii) Curing the composition with water;
wherein the substrates SI and S2 are the same as or different from one another.

In addition, the composition according to the invention can also be used in a method of sealing or coating comprising the steps:

i) Application of a composition according to the preceding description on a substrate SI and/or between two substrates SI and S2;
ii) Curing the composition with water, especially in the form of humidity; wherein the substrates SI and S2 are the same as or different from one another.

Especially suitable as substrates S1 and/or S2 are substrates selected from the group consisting of concrete, mortar, brick, tile, plaster, a natural stone such as granite or marble, glass, glass-ceramic, metal or metal alloy, wood, plastic and lacquer.

The composition according to the invention preferably has a pasty consistency with structurally viscous properties. A composition of this type is applied to the substrate using a suitable device, preferably in the form of a bead, wherein this advantageous has an essentially round or triangular cross sectional area. Suitable methods for applying the composition are, for example, application from commercially available cartridges, operated manually or using compressed air, or from a drum or hobbock using a delivery pump or an extruder, optionally by means of an application robot. A composition according to the invention with good application properties has a high stability under load and short stringing. In other words, after the application it remains in the applied form, thus does not flow apart, and after lifting of the application device, no string or only a very short string is produced, so that the substrate does not become soiled.

The composition according to the invention is especially applied in a temperature range between 5 and 45° C., preferably in the range of room temperature, and cures even under these conditions.

In addition, the invention relates to a cured composition that can be obtained from a composition as described in the preceding after curing with water, especially in the form of atmospheric humidity.

The articles bonded, sealed or coated with a composition according to the invention are especially edifices, especially an above-ground or below-ground edifice, an industrially manufactured product or a consumer product, especially a window, a household appliance, a means of conveyance or an accessory for a means of conveyance.

### EXAMPLES

Embodiments are presented below to further explain the invention described. Naturally the invention is not limited to these embodiments described.

### Test Methods

The tensile strength, the elongation at break, and the modulus of elasticity at 0 to 5% elongation were determined according to DIN 53504 (crosshead speed: 200 mm/min) on films with a layer thickness of 2 mm cured for 7 days at 23° C. and 50% relative humidity.

The tensile shear strength was determined according to ISO 4587/DIN EN 1465 on a Zwick/Roell Z005, wherein in each case two identical glass substrates were bonded together (bonding surface: 12×25 mm; layer thickness: 4.0 mm; measurement speed: 20 mm/min; temperature: 23° C. (unless stated otherwise). The curing of the compositions was performed for 7 days at 23° C. and 50% relative humidity.

The Shore A hardness was determined according to DIN 53505 on test pieces with a layer thickness of 6 mm cured for 7 days at 23° C. and 50% relative humidity.

The skin formation time (“tack-free time”) was determined at 23° C. and 50% relative humidity. For determining the skin formation time, a small portion of the adhesive at room temperature was applied at a layer thickness of about ca. 2 mm to cardboard and the time required until for the first time, when a LDPE pipette was tapped lightly on the surface of the adhesive, no residue remained on the p pette.

The tear propagation resistance was determined according to DIN 53515, on films cured for 7 days at 23° C. and 50% relative humidity with a layer thickness of 2 mm.

### Production of the Silane-Functional Polyurethane Polymer SH

Under a nitrogen atmosphere, 1000 g of the polyol Acclaim® 12200 (Bayer MaterialScience AG, Germany; low monol polyoxypropylene diol; OH number 11.0 mg KOH/g; water content approx. 0.02% by weight), 46.17 g isophorone diisocyanate (Vestanat® IPDI), 261.72 g diisodecyl phthalate (Palatinol® Z) and 0.14 g di-n-butyl-tin dilaurate (Metatin® K712, Acima AG, Switzerland) was heated to 90° C. while stirring constantly and held at this temperature. After one hour of reaction time, a free isocyanate group content of 0.70% by weight (titration) was reached. Then 69.88 g N-(3-trimethoxysilyl-propyl)-amino-succinic acid diethyl ester was added and agitation continued for an additional 2 to 3 hours at 90° C. The reaction was interrupted as soon as no further free isocyanate could be determined by IR spectroscopy (2275-2230 cm⁻¹). The product was cooled to room temperature (23° C.) and stored under exclusion of moisture (theoretical polymer content=90%). The silane-functional polyurethane polymer SH produced in this way is liquid at room temperature.

N-(3-trimethoxysilyl-propyl)-amino-succinic acid-diethyl ester was produced as follows: 51.0 g 3-aminopropyl-trimethoxysilane (Silquest® A-1110, Momentive Performance Materials Inc., USA) was placed in a vessel. Under good agitation, 49.0 g maleic acid diethyl ester (Fluka Chemie GmbH, Switzerland) was slowly added at room temperature and the mixture agitated for 2 hours at room temperature.

### Production of the Adhesives

In a vacuum mixer, corresponding to the parts by weight given in Tables 1 to 3, the silane-functional polymer SH, diisodecyl phthalate (DIDP) and vinyltrimethoxy silane (drying agent, Silquest® A-171 from Momentive Performance Materials Inc., USA) were mixed well for 5 minutes. Then dried, precipitated chalk (Socal® U1S2, Solvay SA, Belgium) was kneaded in for 15 minutes at 60° C. The heater was turned off and N-(2-aminoethyl)-(3-aminopropyl)trimethoxy silane (adhesion promoter, Silquest® A-1120 from Momentive Performance Materials Inc.), di-w-butyl-tin dilaurate (DBTDL, Metatin® K712, added as 10% solution in DIDP) and/or titanate (Tyzor® IBAY from Dorf Ketal) were worked in under vacuum for 10 minutes to form a homogeneous paste. This was then packed into an internally lacquered aluminum expanding plunger cartridge.

TABLE 1
Adhesive compositions in parts by weight and results

| | 1 | 2 | 3 | 4 | 5 | 6 |
|---|---|---|---|---|---|---|
| SH | 30 | 30 | 30 | 30 | 30 | 30 |
| DIDP | 22.9 | 22.8 | 22.7 | 22.4 | 22.1 | 21.8 |
| Silquest ® A-171 | 1 | 1 | 1 | 1 | 1 | 1 |
| Socal ® U1S2 | 45 | 45 | 45 | 45 | 45 | 45 |
| Silquest ® A-1120 | 1 | 1 | 1 | 1 | 1 | 1 |
| DBTDL | 0.1 | 0.2 | | | | |
| Tyzor ® IBAY | | | 0.3 | 0.6 | 0.9 | 1.2 |
| Tensile strength [MPa] | 2.2 | 1.7 | 2.1 | 2.2 | 2.2 | 2.3 |
| Elongation at break [%] | 420 | 330 | 416 | 546 | 579 | 596 |
| Tensile shear strength [MPa] | 1.2 | 0.9 | 1.3 | 1.5 | 1.9 | 2 |
| Tear propagation resistance | 10 | 9 | 11 | 14 | 15 | 15 |
| [N/mm] | | | | | | |
| Modulus of elasticity 0-5% | 1.4 | 1.2 | 0.8 | 0.8 | 1.2 | 1.3 |
| [MPa] | | | | | | |
| Skin formation time [min] | 42 | | >2 h | >2 h | >2 h | 110 |
| Shore A | 39 | 36 | 29 | 30 | 36 | 36 |

TABLE 2
Adhesive compositions in parts by weight and results

| | 1 | 7 | 8 | 9 | 10 |
|---|---|---|---|---|---|
| SH | 30 | 30 | 30 | 30 | 30 |
| DIDP | 22.9 | 22.75 | 22.6 | 22.45 | 22.3 |
| Silquest ® A-171 | 1 | 1 | 1 | 1 | 1 |
| Socal ® U1S2 | 45 | 45 | 45 | 45 | 45 |
| Silquest ® A-1120 | 1 | 1 | 1 | 1 | 1 |
| DBTDL | 0.1 | 0.1 | 0.1 | 0.1 | 0.1 |
| Tyzor ® IBAY | | 0.15 | 0.3 | 0.45 | 0.6 |
| Tensile strength [MPa] | 2.2 | 2.2 | 2.4 | 2.2 | 2.3 |
| Elongation at break [%] | 420 | 457 | 517 | 504 | 574 |
| Tensile shear strength [MPa] | 1.2 | 1.5 | 1.5 | 1.8 | 1.8 |
| Tear propagation resistance | 10 | 10 | 13 | 14 | 15 |
| [N/mm] | | | | | |
| Modulus of elasticity 0-5% | 1.4 | 1.3 | 1.2 | 1.2 | 1.2 |
| [MPa] | | | | | |
| Skin formation time [min] | 42 | 42 | 48 | 52 | 71 |
| Shore A | 39 | 39 | 39 | 38 | 37 |

TABLE 3
Adhesive compositions in parts by weight and results

| | 1 | 11 | 12 | 13 | 14 |
|---|---|---|---|---|---|
| SH | 30 | 30 | 30 | 30 | 30 |
| DIDP | 22.9 | 22.3 | 22.3 | 22.3 | 22.3 |
| Silquest ® A-171 | 1 | 1 | 1 | 1 | 1 |
| Socal ® U1S2 | 45 | 45 | 45 | 45 | 45 |
| Silquest ® A-1120 | 1 | 1 | 1 | 1 | 1 |
| DBTDL | 0.1 | 0.1 | 0.1 | 0.1 | |
| DOTDL | | | | | 0.1 |
| Tyzor ® IBAY | | 0.6 | | | |
| Tytan ™ TAA | | | 0.6 | | 0.6 |
| Tytan ™ S2 | | | | 0.6 | |
| Tensile strength [MPa] | 2.2 | 2.3 | 2.5 | 2.3 | 2.4 |
| Elongation at break [%] | 420 | 574 | 559 | 577 | 591 |
| Tensile shear strength [MPa] | 1.2 | 1.8 | 1.8 | 1.8 | 1.8 |
| Tear propagation resistance | 10 | 15 | 13 | 14 | 14 |
| [N/mm] | | | | | |
| Modulus of elasticity 0-5% | 1.4 | 1.2 | 1.3 | 1.1 | 1.2 |
| [MPa] | | | | | |
| Skin formation time [min] | 42 | 71 | 48 | 75 | 45 |
| Shore A | 39 | 37 | 38 | 37 | 38 |

1. A composition comprising
a. at least one silane-functional polymer P;
b. at least one organotin compound; and
c. at least one titanate,
wherein the proportion of organotin compound is 0.01% to 0.15% by weight and the proportion of titanate is 0.05% to 1-% by weight, in each case based on the entire composition.

2. The composition according to claim 1, wherein the silane-functional polyurethane polymer P is selected from the group consisting of
a silane functional polyurethane polymer P1 obtainable by reacting at least one silane with at least one group reactive toward isocyanate groups with a polyurethane polymer containing an isocyanate groups,
a silane-functional polyurethane polymer P2, obtainable by reacting an isocyanatosilane with a polymer containing functional end groups reactive toward isocyanate groups, and
a silane-functional polymer P3, obtainable by a hydrosilylation reaction of polymers with terminal double bonds.

3. The composition according to claim 1, wherein the organotin compound is a dialkyltin compound.

4. The composition according to claim 1, wherein the proportion of organotin compound is 0.05% to 0.1-% by weight based on the overall composition.

5. The composition according to claim 1, wherein the proportion of titanate is 0.1% to 0.6-% by weight based on the entire composition.

6. The composition according to claim 1, wherein the titanate has at least one multidentate ligand.

7. The composition according to claim 5, wherein the titanate is a titanate of formula (VI) 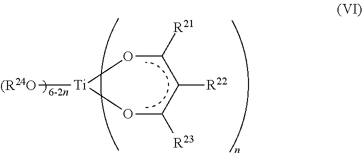
where
R²¹ represents a hydrogen atom or a linear or branched alkyl group with 1 to 8 C atoms;
R²² represents a hydrogen atom or a linear or branched alkyl group with 1 to 8 C atoms, which optionally contains hetero atoms;
R²³ represents a hydrogen atom or an alkyl group with 1 to 8 C atoms or a linear or branched alkoxy group with 1 to 8 C atoms;
R²⁴ represents a linear or branched alkyl radical with 2 to 20 C atoms; and
n represents a value of 1 or 2.

8. A method of crosslinking a composition, the method comprising providing at least one organotin compound together with at least one titanate as catalyst or accelerator system for crosslinking the composition in the presence of water, wherein the composition includes silane-functional polymers, wherein the proportion of organotin compound is 0.01% to 0.15% by weight and the proportion of titanate is 0.05% to 1% by weight, in each case based on the entire composition.

9. An adhesive, sealant or coating comprising the composition according to claim 1.

10. A cured composition obtained from a composition according to claim 1 after curing with water.

11. The composition according to claim 5, wherein the proportion of titanate is 0.1% to 0.3% by weight, based on the entire composition.
